(19) United States
(12) Patent Application Publication
(10) Pub. No.: US 2014/0287766 A1
(43) Pub. Date: Sep. 25, 2014

(54) Communication with a mobile basestation

(71) Applicant: Sivatharan Natkunanathan, Irvine, CA (US)

(72) Inventor: Sivatharan Natkunanathan, Irvine, CA (US)

(21) Appl. No.: 13/815,936

(22) Filed: Mar. 18, 2013

(51) Int. Cl. H04W 88/12; H04W 92/02

(52) U.S. Cl. CPC H04W 88/12; H04W 92/02
USPC 455/445

(57) ABSTRACT

A network with means of a MOBILE BASESTATION (“MBS”), for communication of voice and/or audio, to, and/or from, a TRANSCEIVER DEVICE (“TRD”), other network element, an external device, and/or external network, is the subject of this invention. A MBS system and/or process, is facilitated with means comprising of a MBS, which performs as an intermediary and/or mediator comprising said MBS network.

A single-MOBILE BASESTATION (“SMBS”), and a multi-MOBILE BASESTATION (“MMBS”), system, process, and/or network, does not require a fixed location BaseStation for communication to, and/or from, a MBS network element, MBS, MBS network, external device, and/or external network. A MBS network possesses characteristics, comprising being, wholly mobile, non-dependent in traditional wireless services, instantly deployable independent of location, and operationally mobile friendly.

The invention, a MBS system, process, and/or network, for communication of voice and/or audio, has a multitude of informational, social, professional, and/or consumer applications.

### BACKGROUND OF THE INVENTION

The invention is, a network with means of a MOBILE BASESTATION (“MBS”), and a system and/or process with means comprising of a MBS, for communication of voice and/or audio between network elements, comprising TRANSCEIVER DEVICES (“TRD”s) and/or the connecting likes, comprising said MBS network. The need for a robust communication system and/or process, with means comprising a “mobile local network” is quite demanding.

An application and/or use example of a said system, process, and/or network, is where a person communicates during training of a sporting event, where said person comprising a trainer and/or trainee, maintains intermittent, continuous, and/or ad-hoc communication, with a trainee and/or trainer comprising a local network. The traditional process, is, communication with means of direct human voice and/or audio. Instead, this invention presents a system and/or process for communication of voice and/or audio, with means comprising of a MBS, to, and/or from, a network element comprising said MBS network (“network element”).

An advantage of a MBS system and/or process, is employing comprising a MBS, for mobile local communication. The employment of a MBS is utilitarian, in that, a said MBS network comprises of being, wholly mobile, non-dependent in traditional wireless services, instantly deployable independent of location, and/or operationally mobile friendly.

The application and/or use examples of a MBS system, process, and/or network, comprises, coordinating or communicating with personnel in a warehouse; communicating with children while at a shopping mall, park, and/or the like; and communicating during a hike in the mountain, and/or while at a ranch.

Some of the other advantages of a MBS system, process, and/or network, is the capability to communicate intermittently, continuously, and/or ad-hoc, with means comprising of a MBS. A said communication, comprising a broadcast, one-to-one, one-to-many, and/or many-to-one communication, comprises employing network elements, and additionally, external devices, and/or external networks; where a said external device, comprises a MBS network element, MBS, and/or other device, not of said MBS network; and a said external network, comprises a MBS network, or an other network, not of said MBS network.

A network element of a MBS system, process, and/or network, comprises a device, apparatus, or machine, comprising functionalities and/or use similar to a mobile phone. A said network element, excluding the connecting likes and MBSs, is referred to herein as a “TRANSCEIVER DEVICE”, or simply a “TRD”. A said device, apparatus, or machine, if mobile, is referred to as a “mobile TRANSCEIVER DEVICE” or “mobile TRD”. A TRD and/or a connecting like, excluding MBSs, is referred to herein as a “network element”; and the aforesaid excluding TRDs, is referred to as an “other network element”.

A MBS network does not require a fixed location BaseStation, nor the internet, for operation thereof. However, a said network may employ an external communication device, network, infrastructure, and/or additional services, comprising any of one or more fixed location BaseStations, and/or the internet, for communication and/or operations, to, from, and/or with, an external communication device, apparatus, or machine (“external device”); and/or an external communication network (“external network”); where a said external device, comprises a MBS network element, MBS, and/or other device, not of said MBS network; and a said external network, comprises a MBS network, or an other network, not of said MBS network.

### 1. Introduction

A network with means of a MOBILE BASESTATION (“MBS”), for communication of voice and/or audio, to, and/or from, a pre-authorized and/or authorized network element comprising a MBS network, is the subject of this invention. The scope of this invention, further comprises communication of voice and/or audio, to, and/or from, a pre-authorized and/or authorized external device and/or network.

A MBS is a vital element of a system, process, and/or network, of this invention. A MBS, without capability to form a complete MBS-MBS network connecting with another MBS, is referred to herein as a single-MOBILE BASESTATION (“SMBS”), and that with capability to form a complete MBS-MBS network connecting with another MBS, is referred to herein as a multi-MOBILE BASESTATION (“MMBS”). The specification herein, refers to a system, process, and/or network, comprising of a master-SMBS and/or the said network SMBS (“master-SMBS”), as a SMBS system, process, and/or network; and that, comprising of a master-MMBS and/or a said network MMBS, as a MMBS system, process, and/or network.

The specification herein, for purposes of generality, refers to a SMBS, or MMBS, as a MBS; and a SMBS and/or MMBS system, process, and/or network, as a MBS system, process, and/or network. Further, for purposes of this specification, claims, and abstract, a device, apparatus, or machine, is referred to as a “device”.

For purposes of simplicity, going forward on this specification, a network element or a connecting like comprising a MBS network, excluding MBSs, will be treated as a TRD; a MBS, excluding a master-SMBS comprising a SMBS network, and a master-MMBS and/or a said network MMBS in a MMBS network, will be treated as a TRD, or alternatively, as an external MBS or device; and another MBS network, treated as an external network.

The invention is, a network with means of a MBS, and a system and/or process with means comprising of a MBS, for communication of voice and/or audio between network elements, external devices, and/or external networks. A said MBS network, is facilitated with means of, (1) a master-SMBS, or (2) a master-MMBS and/or a said network MMBS, for performance comprising said network.

### 2. Description of Prior Art

Prior art relating to this invention, is minimal or nonexistent. A few examples of prior art that are proximate to this invention, are described herein following.

The traditional prior art, comprises the use of direct human voice and/or audio for communication between individuals. In circumstances for a said communication to greater distances, the widely employed means comprise communication of voice and/or audio, with means of phone communication. In mobile circumstances, the said means comprise mobile communication, with means of a mobile system, process, and/or network, comprising of a phone, and a fixed location or portable BaseStation. Similarly, in extra-terrestrial circumstances, the means employed comprise satellite communication, with means of a satellite system, process, and/or network, comprising of a phone, and an extra-terrestrial satellite.

A proximate prior art, that comprises being employed in a warehouse setting, comprises, broadcast communication with means of a speaker and/or telecommunication system, process, and/or network; and/or personnel communication with means of a phone and/or computer network.

Another proximate prior art, comprises wireless communication with means of device networking, said means comprising employment of Bluetooth technology, for enabling wireless communication within a short distance of a Bluetooth adapter and/or controller. However, the drawback of the said technology, is the requirement for a said network device to be present within a limited distance, of approximately a standard ten meters, from a Bluetooth adapter and/or controller. The said technology therefore, is constrained by limitations in the range of coverage for wireless communication.

Another prior art, comprises employing of a portable BaseStation for mobile communication in a local network. However, the disadvantage of the aforesaid, is that a said BaseStation is heavy, one-user carried, and not mobile friendly.

In contrasting to the prior art, this invention presents a scalable local network, with means of a MBS, for communication of voice and/or audio.

### 3. Objectives and Advantages

The objective of this invention, is in presenting, a mobile local network with means of a MBS; and a system and/or process with means comprising of a MBS; for intermittent, continuous, and/or ad-hoc, communication of voice and/or audio. A said MBS system, process, and/or network, comprises characteristics of, deployment instantaneously, and/or mobile friendly operation. A said MBS network, comprises network elements with capability for hands-free rugged use.

An advantage of a MBS network, is the scalability of the MBS system, process, and/or network, with means comprising of a MBS. The scalability thereof, is further facilitated, with means of a network element comprising a direct communication to, and/or from, another network element, an external device, and/or external network.

A MBS system and/or process, facilitates communication of voice and/or audio with means comprising of a MBS, to and/or from, a network element, an external device, and/or external network.

### SUMMARY OF THE INVENTION

This invention presents a local network, with means of a MOBILE BASESTATION (“MBS”), for communication of voice and/or audio. A MBS system and/or process of this invention, comprises employing of a MBS, for communication between, network elements comprising said network (“network elements”), other MBSs comprising said network (“MBSs”), external devices, and/or external networks; where a said MBS network, MBS, and/or MBS network element, comprises connecting to, and/or from, external devices and/or networks.

For purposes of simplicity, a one-, two-, and/or multi-way communication, is detailed herein for a network element, namely a TRD comprising a MBS network, with similar details comprising for, other network elements, MBSs, external devices, and/or external networks.

A network element, comprising a TRD, with voice and/or audio communication capability similar to a mobile phone, employs a MBS system, process, and/or network, for transmission and/or reception (“communication”) of voice and/or audio signals. A said network element comprises a TRD transmitter, TRD receiver, and/or TRD transceiver, for performing communication and/or signal processing operations thereof. The said network element, similar to a mobile phone device, comprises, a microphone, speaker, microcontroller, processor, memory, and/or the like, for performing communication.

A MBS, is similar in functionality to a fixed location BaseStation employed for mobile phone network communication. The analogy of a SMBS network, is, employing of only one fixed location BaseStation (disregarding at all times the other fixed location BaseStations) for performing network and/or communication operations of, and/or on, elements comprising said network. The analogy of a MMBS network, is, employing any of one or more fixed location BaseStations for performing network and/or communication operations of, and/or on, other fixed location BaseStations, and/or elements comprising said network. A SMBS, and/or MMBS, comprise connecting to, and/or from, an external MBS, for network and/or communication operations.

A MBS comprises being user carriable and/or possessable, and additionally mobile. However, it has a shorter range of coverage, limited power, and lower capacity, as compared to a fixed location BaseStation employed in mobile phone networks.

The functionality of a MBS, comprises, facilitating network connecting, and/or communication connections, to and/or from network elements, other MBSs, external devices, and/or external networks. A said MBS, comprises performing as an intermediary, and/or mediator, for operations comprising a MBS network.

In a SMBS system, process, and/or network, TRDs comprising namely, TRD1, TRD2, . . . and TRDN, with N being the total number of TRDs; and/or other network elements; transmit and/or receive voice and/or audio signals, with means comprising a master-SMBS comprising said network. However, in a MMBS system, process, and/or network, TRDs, and/or other network elements, transmit and/or receive voice and/or audio signals, with means comprising a master-MMBS and/or a said network MMBS comprising said network.

A MBS system, process, and/or network, facilitates a broadcast, one-way, and/or multi-way communication, with means comprising a MBS, to and/or from a network element, external device, and/or external network. A said system, process, and/or network, further comprises facilitating a half- and/or full-duplex two-way, and/or multi-way communication, with means comprising a MBS, to and/or from a network element, external device, and/or external network. A said system, process, and/or network, comprises facilitating communications further, with means comprising more than one MBS, to and/or from a network element, external device, and/or external network.

A network element, comprises a requirement to be within range of coverage of a MBS of, and/or comprising, said network, for establishing a network element-MBS network connecting; whereas, the call initiating, and recipient, network element comprises requiring to be within range of coverage of a MBS of, and/or comprising, said network, comprising additionally a network of said MBSs, for communication connecting.

A SMBS system and/or process, comprises employing the means of a master-SMBS, for enabling communication between network elements, other MBSs, external devices, and/or external networks, connecting to, and/or from, said SMBS network, SMBS, and/or SMBS network element. Similarly, a MMBS system and/or process, comprises employing the means of a master-MMBS and/or a said network MMBS, for enabling communication between network elements, other MBSs, external devices, and/or external networks, connecting to, and/or from, said MMBS network, MMBS, and/or MMBS network element. A MMBS network, in contrary to a SMBS network, comprises being extensible for network coverage.

In a circumstance when a master-SMBS times-out of a SMBS network, the said network, MBSs, and/or SMBS network elements, comprise a reset and/or synchronization upon said SMBS timing-in. However, in a circumstance when a MMBS comprising a MMBS network, times-out and/or goes-out of said network, and/or a MMBS times-in and/or comes into said network, the said network, MBSs, and/or MMBS network elements, comprise a reset and/or synchronization upon said MMBS timing-in, and/or coming-thereinto. A said reset, and/or synchronization, comprises reassigning and/or assigning of network connecting, for, other MBSs, MBS network elements, external devices, and/or external networks, comprising, and/or within range of, said MBS and/or MBS network.

Herein following are details of the vital elements of a MBS network.

(1) A Mobile Basestation (“MBS”)

A MOBILE BASESTATION, referred to herein as a “MBS”, is a user carriable and/or possessable mobile device, for performing functionalities similar to a fixed location BaseStation employed in mobile phone networks. In addition to said functionalities, a MBS comprises performing command, control, communication, and/or coordination, with a network element, another MBS, said MBS network, an external device, and/or external network. A MBS operation comprises synchronizing a MBS system, process, and/or network, comprising on the mobility of a network element, MBS, external device, and/or external network, connecting to, and/or from, said MBS network.

A MBS, without capability to form a complete MBS-MBS network connecting, is referred to as a SMBS; and that with capability to form a complete MBS-MBS network connecting, is referred to as a MMBS. However, a SMBS may network communicate with means of another MBS, without forming a complete MBS-MBS network connecting. A said communication is facilitated with means comprising of a master-SMBS, without neither losing it's, nor making lose another's, character as a SMBS. A network, consisting only one MBS, will be treated similar to a SMBS network going forward herein.

Mobile synchronization is a vital feature of a MBS system, process, and/or network, since network performance, comprising between a MBS, and a network element, is a dependent variable of the relative distance between said MBS, and said network element connecting thereto.

A MBS comprises being assigned a master-MBS, for a MBS system, process, and/or network. A network, with means of a master-SMBS, is referred to as a SMBS network; and that, with means of a master-MMBS and/or a said network MMBS, is referred to as a MMBS network. The aforesaid is generally referred to, as a MBS network, comprising within the definition a SMBS and/or MMBS network.

(2) A Transceiver Device (“TRD”)

A device for a MBS network, for communication of voice and/or audio, with means comprising of a MBS, is referred to herein as a “TRANSCEIVER DEVICE”, or simply a “TRD”. The aforesaid, if mobile, is referred to as a “mobile TRANSCEIVER DEVICE” or “mobile TRD”. A TRD comprises, a microphone, speaker, microcontroller, processor, memory, and/or the like, that forms comprising a miniature device.

A TRD comprises a requirement, to be within range of a minimum of one MBS, comprising a network of MBSs, for connecting in, to, and/or from, a MBS network. A TRD receives signals thereto, and/or transmits signals therefrom, with means comprising of a MBS in, and/or comprising, said network. A TRD comprises communicating to, and/or being communicated from, an external device, and/or network, either directly, or indirectly with means comprising of a MBS. A said TRD when out-of-range of its MBS network, comprises employing an external device, network, infrastructure, and/or service, for performing operations thereof.

(3) An Other Network Element

A device or a like for a MBS network, excluding a TRD and MBS, for communication of voice and/or audio, with means comprising of a MBS, is referred to herein as an “other network element”. A said other network element, comprises of an existing, enhanced, and/or new communication device, or a like, that is enabled capabilities similar to a TRD. A said capability for a MBS network, is enabled with means comprising equipping, installing, and/or plugging-in, of a device and/or network adapter into said other network element. An example of an aforesaid, comprises of an existing, enhanced, and/or new device, comprising a computer, phone, and/or a like, for a MBS network.

### DESCRIPTION OF THE DRAWINGS

The objectives of the invention will become more apparent, and the invention best understood from the following description of a MBS system, process, and/or network, when read in reference to the illustrated drawings, wherein:

FIG. 1 illustrates a broadcast communication in a SMBS network.

FIG. 2 illustrates a one-way communication to a selected TRD in a SMBS network.

FIG. 3 illustrates a one-way communication to selected TRDs in a SMBS network.

FIG. 4 illustrates a two-way communication, between two TRDs in a SMBS network.

FIG. 5 illustrates a two-way communication, between TRDs in a SMBS network.

FIG. 6 illustrates a broadcast communication in a MMBS network.

FIG. 7 illustrates a one-way communication to a selected TRD in a MMBS network.

FIG. 8 illustrates a one-way communication to selected TRDs in a MMBS network.

FIG. 9 illustrates a two-way communication, between two TRDs in a MMBS network.

FIG. 10 illustrates a two-way communication, between TRDs in a MMBS network.

FIG. 11 illustrates an instantaneous shortest distance network element-MMBS network connecting method for a MMBS system, process, and/or network.

FIG. 12 illustrates an external device and/or network, connecting to a SMBS network, SMBS, and/or SMBS network element.

FIG. 13 illustrates an external device and/or network, connecting to a MMBS network, MMBS, and/or MMBS network element.

FIG. 14 illustrates a SMBS network element, SMBS, and/or SMBS network, connecting to an external network and/or device.

FIG. 15 illustrates a MMBS network element, MMBS, and/or MMBS network, connecting to an external network and/or device.

### DESCRIPTION OF A MBS SYSTEM, PROCESS, AND NETWORK

A system, process, and/or network, comprising of a master-SMBS, is a SMBS system, process, and/or network; whereas a system, process, and/or network, comprising of a master-MMBS and/or a said network MMBS, is a MMBS system, process, and/or network. A said system, process, and/or network, is generally referred to as a MBS system, process, and/or network, consisting within the definition, a SMBS and/or MMBS system, process, and/or network.

A MBS performs, comprising for network connecting network elements, other MBSs, external devices, and/or external networks, in, to, and/or from, a MBS network. Among other functionalities, a MBS comprises performing operations for coordinating, and/or synchronizing, of elements comprising said MBS network.

A network element user, comprises carrying and/or possessing mobile TRD1, and SMBS1, in a SMBS network. Similarly, a network element user, comprises carrying and/or possessing mobile TRD1, and MMBS, in a MMBS network, comprising with other network element users comprising said MMBS network, carrying and/or possessing mobile TRDm, and MMBSm; where m is 2, 3, . . . , or M; and M the total number, comprising operational network accumulative, independent, MMBSs comprising said MMBS network.

A user carriable and/or possessable network element, and/or MBS, is independent in embodiment. An enhancement of said, comprises integration of a said network element, and/or MBS, into a system-on-a-chip referred to as “SOC”, a mobile system-on-a-chip referred to as “mobile SOC”, and/or an integrated component, part, device, and/or product.

A network element, and a MBS, employs the means of a battery as a source for supply-power. However, when both of said devices are carried and/or possessed by the same individual, and/or integrated together, a said device may share the battery employed by the said other. An enhancement of a network element, and a MBS, is in receiving supply-power from a renewable energy source.

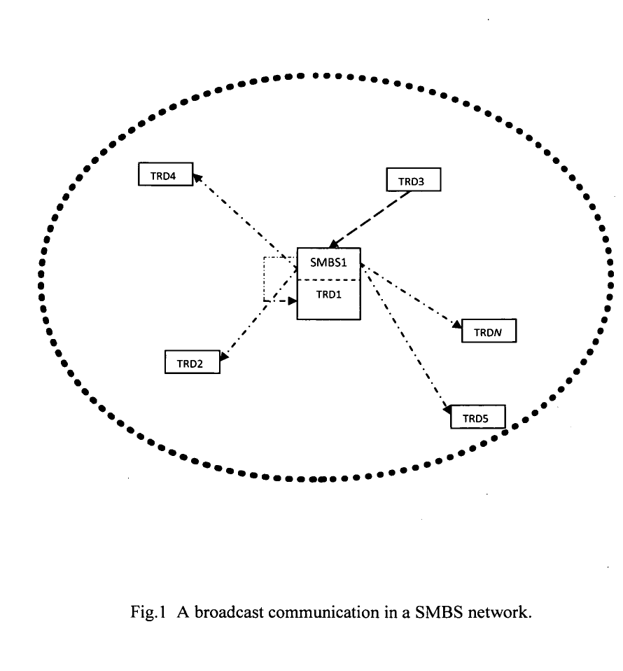

FIG. 1 illustrates a SMBS system and/or process for a broadcast communication, with means comprising of a SMBS comprising a SMBS network. Here, other MBSs comprising said network, form a MBS-SMBS network connecting, with a master-SMBS comprising SMBS1, for network and/or communication operations in, and/or of, said network. A said network operation comprises finding, the relative distance of network elements, other MBSs, external devices, and/or external networks, from said master-SMBS and/or a MBS comprising said network; and/or the location thereof; and updating of said findings in said network. The said figure shows TRD3 performing broadcast communication, with means of SMBS1, to network elements and/or other MBSs comprising, and/or within range of, said SMBS network.

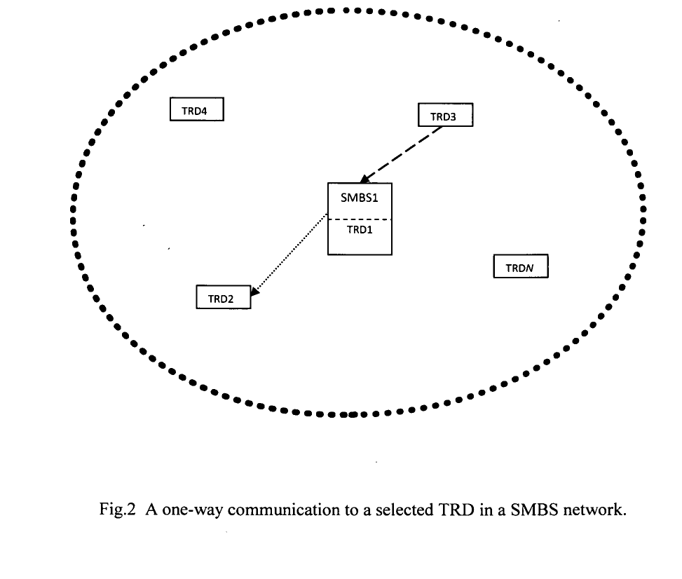

FIG. 2 illustrates a SMBS system and/or process for a one-way communication, with means comprising of a SMBS, to a user selected network element, comprising a SMBS network. In one-way communication, a network element one-way communicates with means comprising of a MBS, to another network element. The said figure shows a one-way communication from TRD3, to TRD2, with means of SMBS1 in said SMBS network.

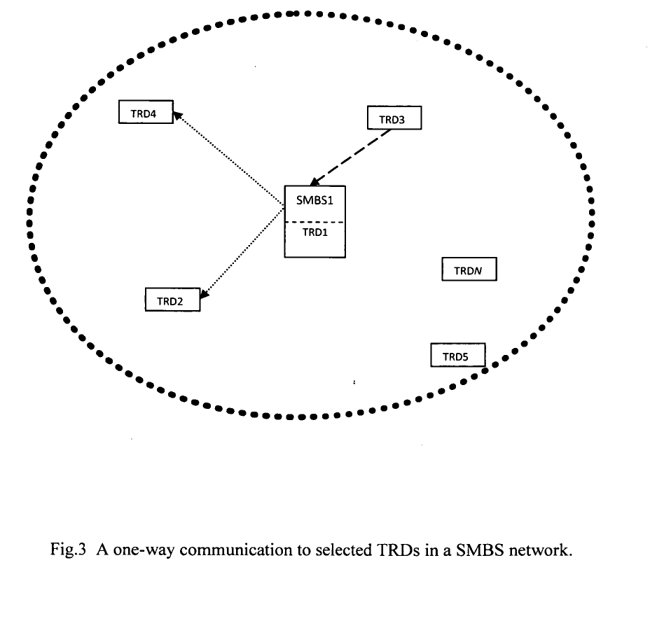

FIG. 3 illustrates a SMBS system and/or process for a one-way communication, with means comprising of a SMBS, to user selected network elements, comprising a SMBS network. The said figure shows a one- and/or multi-way communication, from TRD3, to TRD2 and/or TRD4, with means of SMBS1 in said SMBS network.

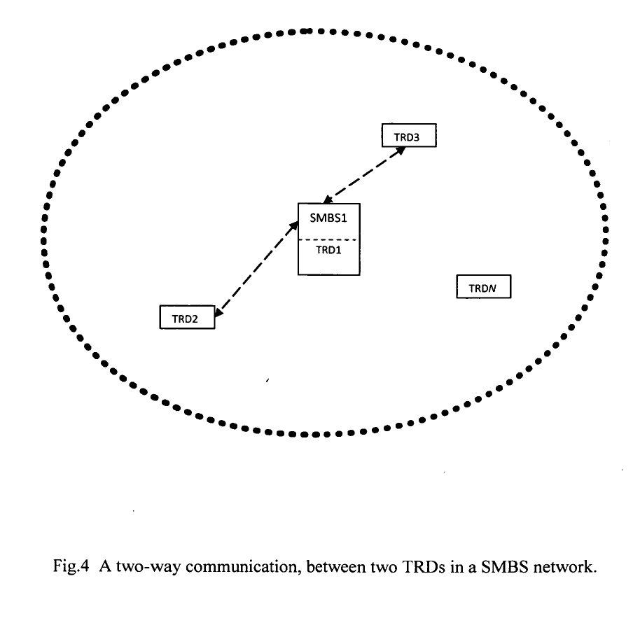

FIG. 4 illustrates a SMBS system and/or process for a two-way communication, with means comprising of a SMBS, between two network elements, comprising a SMBS network. In two-way communication, network elements comprise employing half and/or full duplex two-way communication, with means comprising of a MBS, between each other. The said figure shows two-way communication, between TRD2, and TRD3, with means of SMBS1 in said SMBS network.

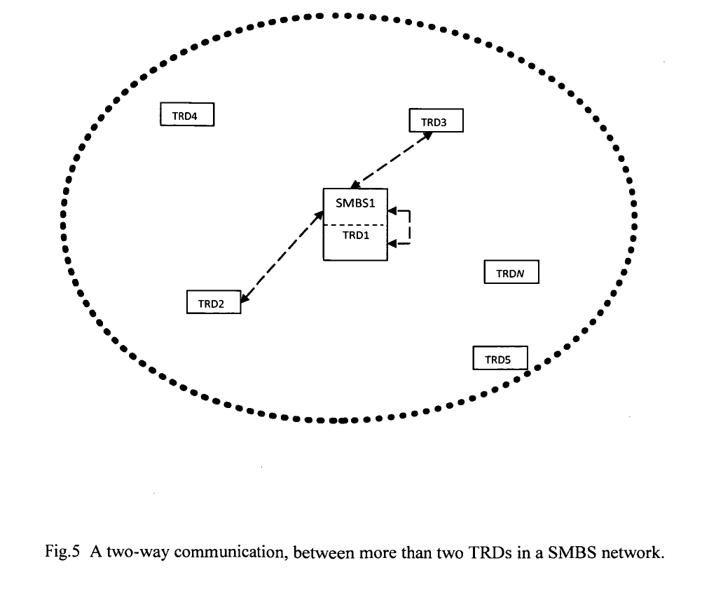

FIG. 5 illustrates a SMBS system and/or process for a two-way communication, with means comprising of a SMBS, between more than two network elements, comprising a SMBS network. A said system and/or process, has a minimum of two network elements, employing half and/or full duplex two-way communication between each other, comprising multi-way communication to and/or from other participant network elements, with means of a master-SMBS comprising said network. The said figure shows two- and/or multi-way communication, between TRD1, TRD2, and/or TRD3, with means of SMBS1 in said SMBS network. The said communication, comprises, similarity to conference calling utilizing a phone system, process, and/or network, where participant network elements independently transmit, and/or receive another network element's transmissions of, voice and/or audio signals.

In a SMBS system and/or process, network elements, other MBSs, external devices, and/or external networks, communicate with means comprising of a master-SMBS comprising said SMBS network. In contrasting thereto, in a MMBS system and/or process, network elements, other MBSs, external devices, and/or external networks, communicate with means comprising any of one or more MMBSs comprising said MMBS network. A MBS network element, at times however, may perform communications directly to, and/or from, another network element, an external device, and/or external network, with means of a MBS system, process, and/or network.

A network element comprising a SMBS network, establishes network and/or communication operations, with means of a master-SMBS comprising said network. The connecting for communication between network elements, is established with means comprising a network communication channel, between a call initiating, and recipient, network element connecting to a master-SMBS comprising said SMBS network.

A network element comprising a MMBS network, establishes network and/or communication operations, with means of a MMBS comprising said network, comprising a said MMBS shortest in distance thereto. The connecting for communication between network elements, is established with means comprising a network communication channel, between, a call initiating, and recipient, network element connecting to any of, one of, said MMBSs; and connecting for communication between the said communication network element connecting MMBSs; comprising a MMBS network.

A one-, two-, and/or multi-way communication in a MBS network, comprises a call session, with means comprising of a MBS, similar to that employed in mobile phone networks. An advantage of a MMBS system, process, and/or network, over that of a SMBS, comprises extensibility of a MMBS system, process, and/or network.

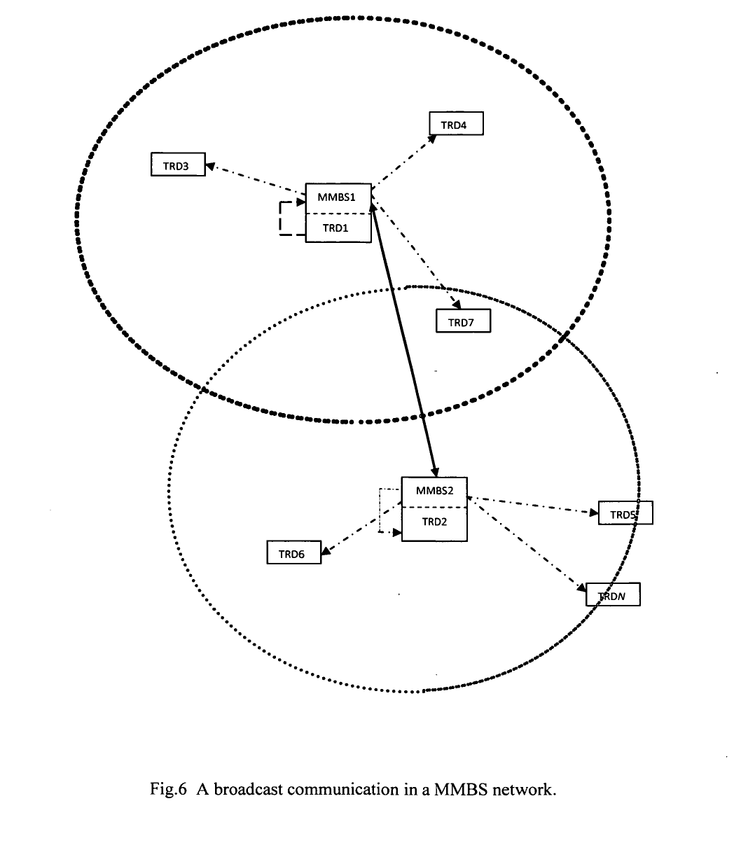

FIG. 6 illustrates a MMBS system and/or process for a broadcast communication, with means comprising of MMBS1, and/or MMBS2, comprising a MMBS network. Here, MMBS2, and other MBSs, form a MBS-MMBS network connecting, with a master-MMBS and/or a said network MMBS comprising MMBS1, for network and/or communication operations comprising said network. A said network operation comprises for finding, the relative distance of network elements, other MBSs, external devices, and/or external networks, from a pre-assigned, one, or any, MBS comprising said network; and/or the locations thereof; and updating of said findings in said network. The said figure shows TRD1 performing broadcast communication, with means of MMBS1, and/or MMBS2, to network elements and/or other MBSs comprising, and/or within range of, said MMBS network.

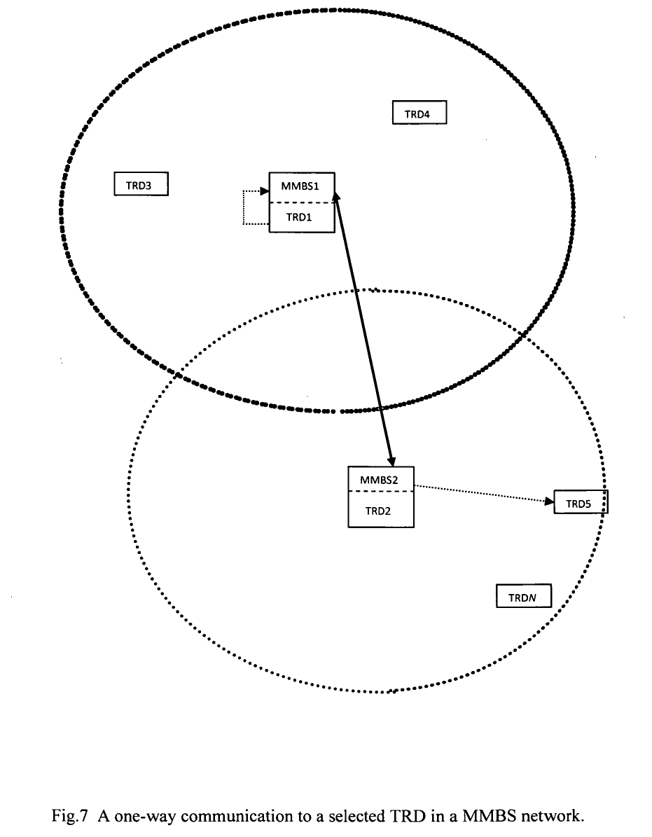

FIG. 7 illustrates a MMBS system and/or process for a one-way communication, with means comprising of a MMBS, to a user selected network element, comprising a MMBS network. The said figure shows a one-way communication from TRD1, to TRD5, with means of MMBS1, and/or MMBS2, in said MMBS network.

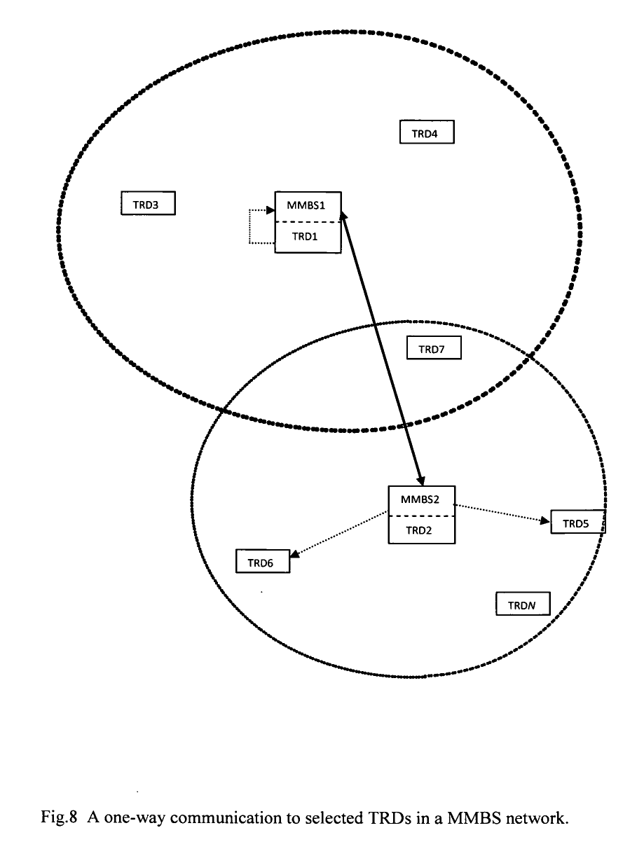

FIG. 8 illustrates a MMBS system and/or process for a one-way communication, with means comprising of a MMBS, to user selected network elements, comprising a MMBS network. The said figure shows a one- and/or multi-way communication from TRD1, to TRD5 and/or TRD6, with means of MMBS1, and/or MMBS2, in said MMBS network.

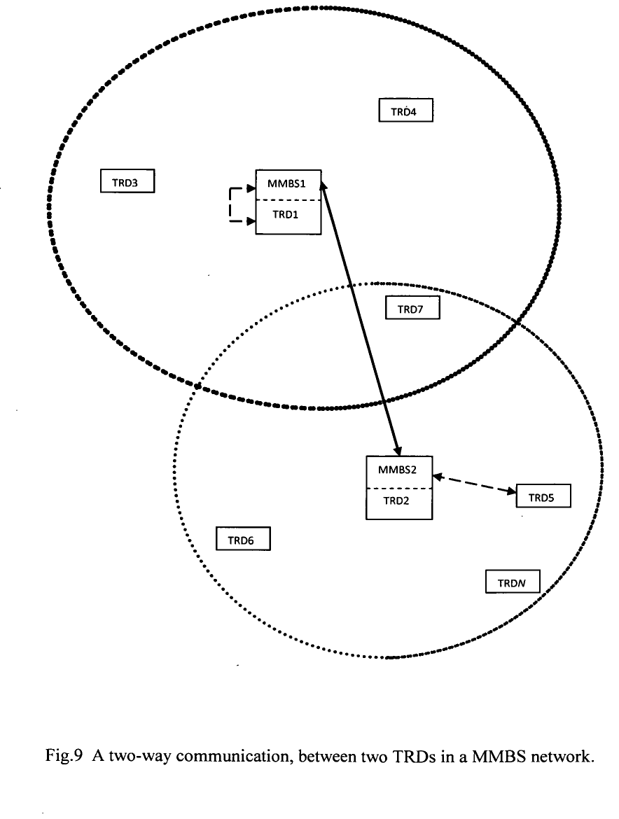

FIG. 9 illustrates a MMBS system and/or process for a two-way communication, with means comprising of a MMBS, between two network elements, comprising a MMBS network. The said figure shows, employing comprising of half and/or full duplex two-way communication, between TRD1, and TRD5, with means of MMBS1, and/or MMBS2, in said MMBS network. During the instance shown on said figure, TRD1 is within range of MMBS1, comprising within range of MMBS2; and TRD5 is within range of MMBS2, but not within range of MMBS1. A network connecting, comprising on an instantaneous shortest distance network element-MMBS connecting method, comprises between said TRD1 and MMBS1, and TRD5 and MMBS2 or MMBS1. A network communication connection, between MMBS1, and MMBS2, comprises presenting a partial network communication channel, for communication between said network elements. The network communication channel for the aforesaid, during the said instance, comprises,

TRD1<=>MMBS1<===>MMBS2<=>TRD5 between TRD1, and TRD5.

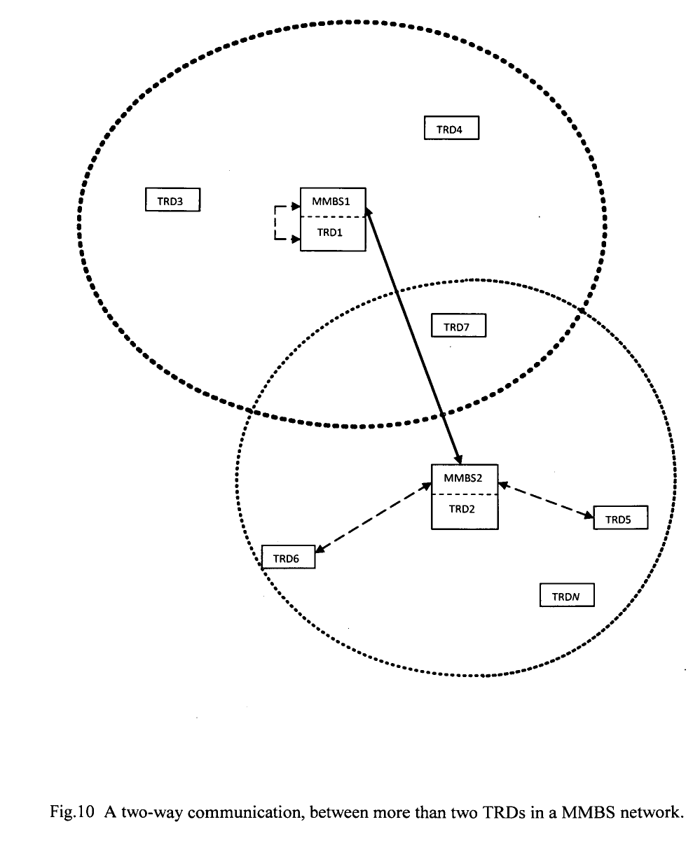

FIG. 10 illustrates a MMBS system and/or process for a two-way communication, with means comprising of a MMBS, between more than two network elements, comprising a MMBS network. A said system and/or process, has a minimum of two network elements, employing comprising half and/or full duplex two-way communication between each other, comprising multi-way communication to other participant network elements. The said figure shows two- and/or multi-way communication, between TRD1, TRD5, and/or TRD6, with means of MMBS1, and/or MMBS2, in said MMBS network. The said communication, comprises, similarity to conference calling utilizing a phone system, process, and/or network, where participant network elements independently transmit, and/or receive another network element's transmissions of, voice and/or audio signals. The network communication channel for the aforesaid, during the said instance, comprises,

TRD1<=>MMBS1<===>MMBS2<=>TRD5 &/TRD6 between TRD1, & TRD5 &/TRD6;

and TRD5<=>MMBS2<=>TRD6 between TRD5, and TRD6.

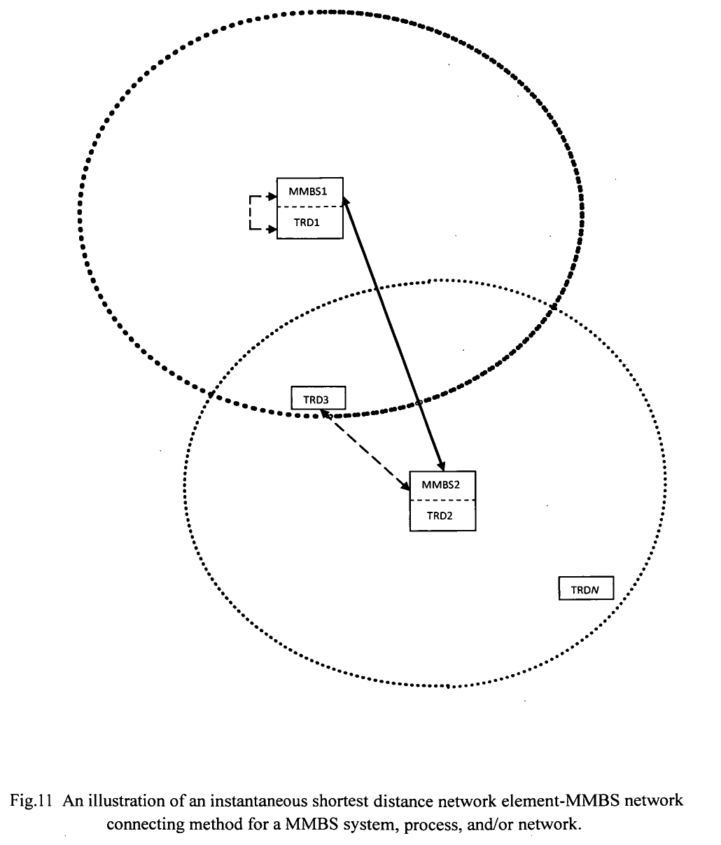

FIG. 11 illustrates a MMBS system, process, and/or network, where network elements comprising a MMBS network, establish network connecting with means of a MMBS comprising said network, which is instantaneously shortest in distance thereto. The said figure shows TRD3 within range of both MMBS1, and MMBS2. However, since TRD3 is instantaneously shorter in distance to MMBS2 than MMBS 1, network connecting is established between said TRD3, and MMBS2. Similarly, network connecting is established between TRD1, and MMBS1, the shortest distance MMBS to TRD1. The network communication channel for the aforesaid, during the said instance, comprises,

TRD1<=>MMBS1<===>MMBS2<=>TRD3 between TRD1, and TRD3.

The said shortest distance network element-MMBS network connecting method, for a MMBS system, process, and/or network, comprises being employed when a network element is present within range of coverage of more than one MMBS comprising said MMBS network. The said shortest distance network element-MMBS network connecting method, comprises presenting savings in, network element transmit-receive power, and/or system power comprising said network.

An alternative to said instantaneous shortest distance network element-MMBS network connecting method, comprises employing an advanced, network element-MBS, and/or MBS-MMBS, network connecting method, that optimizes the said comprising on, (1) connecting to the instantaneous shortest distance MBS to a network element, (2) the power constraints of the instantaneous shortest distance MBS to a network element, (3) the power constraints of intra-MMBS network connecting, (4) inter-MBS network connecting, and/or (5) an end-to-end minimum communication-link distance.

In a MMBS network, the MBS-MMBS network connecting method comprises employing a distinct method, than said instantaneous shortest distance network element-MMBS connecting method. A MBS network, comprising, a network element-MBS network connecting method; a MBS-MMBS network connecting method; intra-MBS network connecting method; inter-MBS network connecting method; and/or an end-to-end minimum communication-link distance connecting method; is however, not a limitation of this invention.

In a MBS system and/or process, a network element, an external device, and/or external network, communicates to, from, and/or with, a said another, with means comprising of a MBS comprising said network. A said system and/or process, comprises of an individual and/or group, one-to-one, one-to-many, and/or many-to-one communication. A said communication is facilitated with means comprising user-controls on said network element, said network element connecting MBS, and/or an external controller thereof.

An enhancement of a MBS system, process, and/or network, comprises enabling pushbutton and/or touch user-controls, comprising on each network element, and/or MBS, of said network. A said user-control comprises being, embodied on the network element and/or said network element connecting MBS, installed with means of a device software, and/or facilitated with means of an external controller thereof. Another enhancement of a MBS system, process, and/or network, comprises enabling one-to-many and/or many-to-one communication capability, comprising on each network element, and/or MBS, of said network.

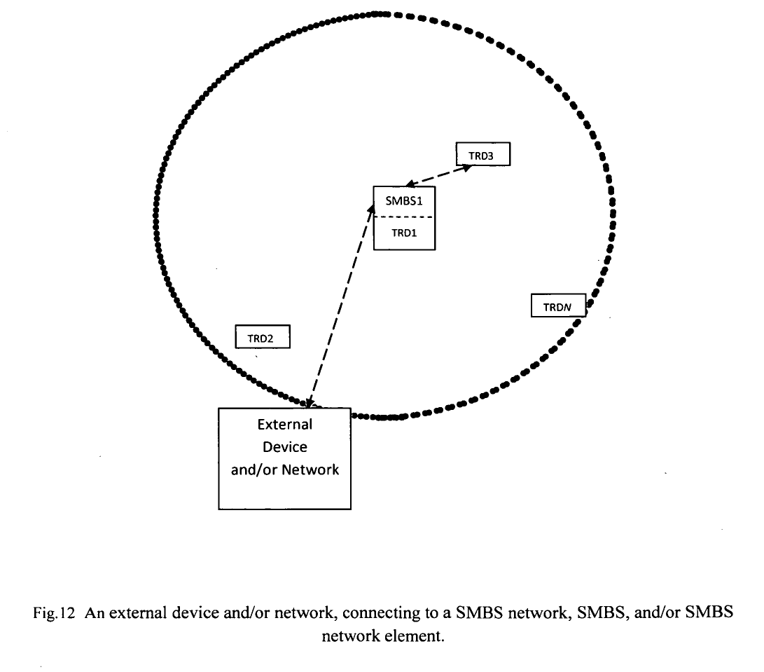

FIG. 12 illustrates a SMBS system and/or process, where an external device and/or network, connects to a SMBS network, SMBS, and/or SMBS network element, with means comprising a MBS comprising said network. The said figure shows a one-, two-, and/or multi-way communication, between an external device and/or network, and TRD3, with means comprising of SMBS1 in said network.

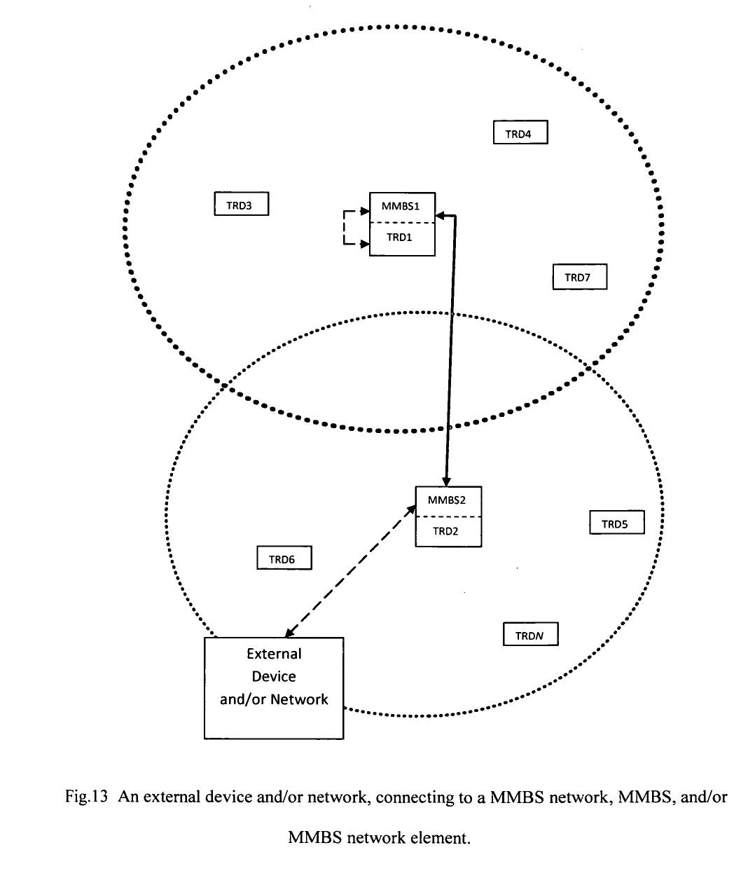

Similarly, FIG. 13 illustrates a MMBS system and/or process, where an external device and/or network, connects to a MMBS network, MMBS, and/or MMBS network element, with means comprising a MBS comprising said network. The said figure shows a one-, two-, and/or multi-way communication, between an external device and/or network, and TRD1, with means comprising of MMBS1, and/or MMBS2, in said network.

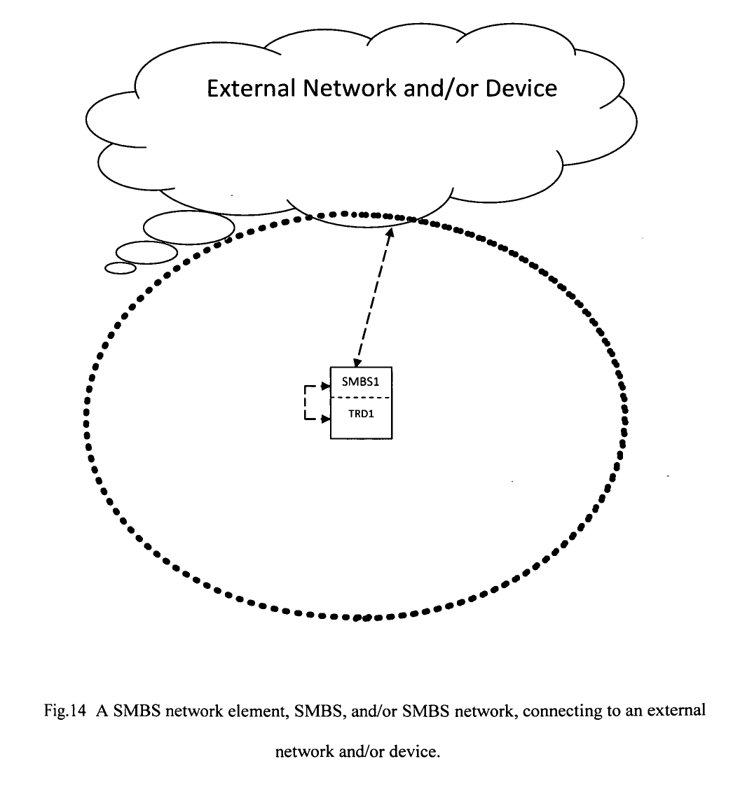

FIG. 14 illustrates a SMBS system and/or process for a SMBS network, where a SMBS network element, SMBS, and/or SMBS network, connects to an external network and/or device, with means comprising a MBS comprising said network. The said figure shows a one-, two-, and/or multi-way communication, between TRD1, and an external network and/or device, with means comprising of SMBS1 in said network.

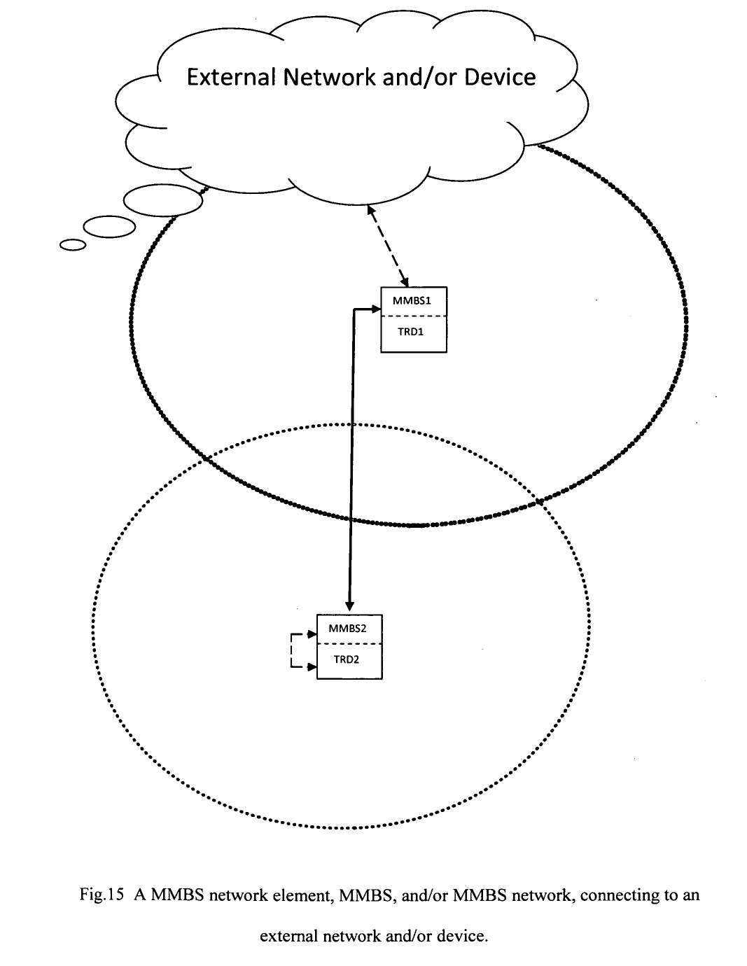

Similarly, FIG. 15 illustrates a MMBS system and/or process for a MMBS network, where a MMBS network element, MMBS, and/or MMBS network, connects to an external network and/or device, with means comprising any of one or more MBSs comprising said network. The said figure shows a one-, two-, and/or multi-way communication, between TRD2, and an external network and/or device, with means comprising of MMBS2, and/or MMBS1, in said network.

The analogy of a SMBS network, comprises, a mobile phone network employing only one fixed location BaseStation (disregarding at all times the other fixed location BaseStations), for performing network and/or communication operations of, and/or on, elements comprising said mobile phone network. The analogy of a SMBS system and/or process, is where a mobile phone comprises employing only one of said fixed location BaseStations, for performing mobile phone operations of, and/or on, said mobile phone, elements comprising said network, external devices, and/or external networks.

Similarly, the analogy of a MMBS network, comprises, a mobile phone network employing any of one or more fixed location BaseStations, for performing network and/or communication operations of, and/or on, elements comprising said mobile phone network. The analogy of a MMBS system and/or process, is where a mobile phone is within coverage of, and comprises employing, any of said one or more fixed location BaseStations, for performing mobile phone operations of, and/or on, said mobile phone, elements comprising said network, external devices, and/or external networks.

An external communication element (“external element”) comprising an external device and/or network, comprises operating and/or co-operating in, and/or with means of, a MBS system, process, and/or network. A said external device, comprises a MBS network element, MBS, and/or other device, not of said MBS network; and a said external network, comprises a MBS network, or an other network, not of said MBS network.

A said operation or co-operation, is facilitated with means comprising connecting a said external element, to a said MBS network, MBS, and/or MBS network element. A said external element, during said operation or co-operation in, and/or with means of, a MBS network, comprises characteristics of, a MBS network element therein, a MBS therein, and/or an extension of said external network into said MBS network. A said external element operation or co-operation, is enabled with means comprising, (1) a device and/or network adapter for a said external device, external network, MBS network, MBS, and/or MBS network element; and/or (2) an operating system, program, application, service, platform, and/or a combination thereof.

Similarly, a MBS network element, MBS, and/or MBS network, comprises operating or co-operating in, and/or with means of, an external element. A said operation or co-operation is facilitated with means comprising connecting a MBS network element, MBS, and/or MBS network, to an external network and/or device. A said, during said operation or co-operation, comprises characteristics of, a said external device, and/or an extension of said MBS network into said external network. A said operation or co-operation, is enabled with means comprising, (1) a device and/or network adapter for a said MBS network element, MBS, MBS network, external network, and/or external device; and/or (2) an operating system, program, application, service, platform, and/or a combination thereof. The aforesaid is referred to as a “MBS mobile network” when a MBS network element, MBS, and/or MBS network, comprises connecting to an external network.

### A MBS Network:

A minimum of one MBS is employed for a MBS network. A said network comprises employing channel coding techniques, and/or encryption methods, for communications therein. A said communication, comprising a call session, is established with means comprising a handshake similar to that employed for a mobile phone communication.

A MBS system and/or process, comprises employing a wireless communication channel, facilitated with means of a network standard and/or protocol. The employing comprising a multiple-access scheme, standard, and/or protocol, presents efficiency for communication in a MBS network. A MBS network scheme, standard, protocol, channel coding technique, encryption method, routing method, nor advanced algorithm, is however not a limitation of this invention.

### A TRD Transmitter:

A TRD transmitter functions similar to a mobile phone transmitter. A said transmitter comprises being equipped in, installed and/or plugged into, a TRD, other network element, an external device, and/or external network. A said transmitter, without a receiver, is capable of transmitting signals comprising for a broadcast, one-way, multi-way, and/or the said TRD transmitter locating communication, with means comprising a network.

An operation of a TRD transmitter, comprises, periodically transmitting signals for synchronizing with a MBS, another network element, an external device, and/or external network. A said transmission, comprises assisting a network for finding, the relative distance of said transmitter from a MBS and/or a network; the location thereof; and/or updating said found relative distance and/or location information for operations of said network. An enhanced feature under limited circumstances, comprises, a TRD transmission of a broadcast, one-way, and/or multi-way communication, directly to another network element, an external device, and/or external network.

### A TRD Receiver:

A TRD receiver functions similar to a mobile phone receiver. A said receiver, without a transmitter, is capable of receiving signals comprising from a broadcast, one-way, and/or multi-way communication, with means comprising a network. An enhanced feature under limited circumstances, comprises, a TRD reception of a broadcast, one-way, and/or multi-way communication, directly from another network element, an external device, and/or external network.

An operation of a TRD receiver, comprises, listening to, and/or receiving of, signals transmitted with means comprising of a MBS, another network element, an external device, and/or external network. The receiving of said signals, enables said device for network and/or communication operations, comprising synchronizing, resetting, and/or channel assigning.

### A TRD Transceiver:

A TRD transceiver, is an integration of a TRD transmitter, and a TRD receiver, into an integrated circuit semiconductor chip, board, device, and/or product. The performance of a said transceiver, comprises functionalities of a TRD transmitter, and a TRD receiver, described herein preceding; and additionally two-way communication capability.

At times, under limited circumstances, a TRD transceiver comprises employing a direct communication to, and/or from, another network element, an external device, and/or external network. A said communication is employed comprising for scaling a MBS system, process, and/or network.

A user operation on a TRD transmitter, receiver, or transceiver, comprises activating, selecting performance constraints, and initiating use, with means comprising user-controls thereon, a said connecting device, a said device software, and/or an external controller thereof. A TRD user, controls performance of a said TRD transmitter, receiver, or transceiver, with means of a default, input, and/or selection; and/or an operating system, program, application, service, platform, and/or a combination thereof.

A communication device and/or network, may employ a transmitter, receiver, and/or transceiver thereof, with a new and/or enhanced device software, and/or software application, for communicating to, from, and/or with a MBS network, MBS, and/or MBS network element.

### An Out of Range Network Element:

A network element, comprises a requirement to be within range of a minimum of one MBS, comprising a network of MBSs, for communication with means of a MBS network. A said network element, at times, comprises direct communication to, and/or from, another network element, an external device, and/or external network, with means of a MBS system and/or process.

In a situational circumstance, when a network element unintentionally goes out of range of a MBS network, location finding means are then deployed, and/or employed, for finding said network element. A MBS system and/or process, for a said location finding operation, comprises, (1) increasing the transmit signal range of said out-of-range network element; (2) increasing the range of coverage of said MBS network; (3) deploying and/or employing of a portable and/or mobile BaseStation with a longer range of coverage; (4) transmitting of an out-of-network distress signal from said network element; (5) employing of an external system, process, and/or service, comprising GPS; and/or (6) employing of an external network, infrastructure, device, and/or service, by the said network element.

An Enhancement of a Network Element and/or MBS:

An enhancement of a TRD, and/or other network element, is integration of a MBS thereinto and/or therewith, with means comprising, a system-on-a-chip referred to as “SOC”; a mobile system-on-a-chip referred to as “mobile SOC”; and/or an integrated circuit semiconductor chip, board, device, and/or product. Similarly, an enhancement of an external device and/or network, comprises integration of a TRD like, a MBS, and/or an application software, thereinto and/or therewith.

A further enhancement of a TRD, and/or MBS, is integration thereof, into an integrated component, part, device, and/or product, comprising plug-and-use capability for use in, and/or with, an external device, external network, MBS network element, MBS, and/or MBS network.

I claim:

1. A single-MOBILE BASESTATION, for communication of voice and/or audio, named or classified a “SMBS”.

2. A network, with means of a SMBS of claim 1, named or classified a SMBS network.

3. A system and/or process, with means of a SMBS network element, SMBS of claim 1, and/or SMBS network, named or classified a SMBS system and/or process.

4. A component, part, device, apparatus, machine, article of manufacture, and/or product, comprising an operating system, program, application, service, platform, and/or a combination thereof, that enables and/or facilitates a SMBS system, process, and/or network of claim 2, comprising connecting to, and/or from, an external device and/or network.

5. A multi-MOBILE BASESTATION, for communication of voice and/or audio, named or classified a “MMBS”.

6. A network, with means of a MMBS of claim 5, named or classified a MMBS network.

7. A system and/or process, with means of a MMBS network element, MMBS of claim 5, and/or MMBS network, named or classified a MMBS system and/or process.

8. A component, part, device, apparatus, machine, article of manufacture, and/or product, comprising an operating system, program, application, service, platform, and/or a combination thereof, that enables and/or facilitates a MMBS system, process, and/or network of claim 6, comprising connecting to, and/or from, an external device and/or network.

9. A SMBS system, process, network, and/or service, for communication of voice and/or audio, with means comprising a SMBS network of claim 2, to, and/or from, a network element, MBS, external device, and/or external network, comprising said SMBS network.

10. A MMBS system, process, network, and/or service, for communication of voice and/or audio, with means comprising a MMBS network of claim 6, to, and/or from, a network element, MBS, external device, and/or external network, comprising said MMBS network.

11. A system, process, network, and/or service, for multi-channel communication with means comprising a SMBS of claim 1, to, and/or from, a SMBS network, MBS, network element, external device, and/or external network.

12. A system, process, network, and/or service, for multi-channel communication with means comprising a MMBS of claim 5, to, and/or from, a MMBS network, MBS, network element, external device, and/or external network.
